(19) United States
(12) Patent Application Publication
(10) Pub. No.: US 2017/0089704 A1
(43) Pub. Date: Mar. 30, 2017

(54) INFORMATION PROCESSING APPARATUS, INFORMATION PROCESSING METHOD, AND COMPUTER PROGRAM

(71) Applicant: SONY CORPORATION, TOKYO (JP)

(72) Inventors: TOMOHISA TAKAOKA, KANAGAWA (JP); MASATOMO KURATA, TOKYO (JP); YOSHIYUKI KOBAYASHI, TOKYO (JP)

(21) Appl. No.: 15/311,597

(22) PCT Filed: Apr. 23, 2015
(86) PCT No.: PCT/JP2015/062335

§ 371 Date: Nov. 16, 2016

(30) Foreign Application Priority Data
May 27, 2014 (JP) 2014-109203

(51) Int. Cl. G01C 21/00; G01C 17/02

(52) U.S. Cl. CPC G01C 21/005; G01C 17/02

(57) ABSTRACT

[Object] To provide an information processing apparatus which can accurately estimate a current position by using a result of action recognition. [Solution] Provided is an information processing apparatus including: an action recognition unit configured to recognize an action of a user that has a sensor by using first sensing data of the sensor; and an accuracy estimation unit configured to estimate an accuracy of second sensing data of a geomagnetism sensor on the basis of a result of action recognition of the user obtained by the action recognition unit.

### CROSS REFERENCE TO RELATED APPLICATIONS

This application is a U.S. National Phase of International Patent Application No. PCT/JP2015/062335 filed on Apr. 23, 2015, which claims priority benefit of Japanese Patent Application No. JP 2014-109203 filed in the Japan Patent Office on May 27, 2014. Each of the above-referenced applications is hereby incorporated herein by reference in its entirety.

### TECHNICAL FIELD

The present disclosure relates to an information processing apparatus, an information processing method, and a computer program.

### BACKGROUND ART

A technology that recognizes an action of a user that has a portable terminal is disclosed (refer to Patent Literature 1, for example). In this technology, a sensor is provided in the portable terminal, and a motion of the user that has the portable terminal is detected by the sensor, and the detected motion is analyzed, in order to recognize the action of the user. The action of the user that has the portable terminal is “traveling by foot”, “traveling by running”, “halt”, “traveling by car” or the like, for example. Also, a technology that can acquire position information of a portable terminal according to an action of a user is disclosed (refer to Patent Literature 2, for example).

An acceleration sensor, a gyro sensor, or the like is used as the sensor that detects the motion of the user that has the portable terminal, and characteristic data such as walking pitch, walking intensity, gravity force direction, direction of forward movement is extracted on the basis of the data detected by these sensors. Also, an acceleration sensor, a gyro sensor, a geomagnetism sensor, or the like is used in estimation of position information and direction information within doors where it is difficult for radio waves from GNSS (Global Navigation Satellite System; satellite positioning system) satellites to reach.

### CITATION LIST

### Patent Literature

Patent Literature 1: JP 2006-345269A

Patent Literature 2: JP 2012-205203A

### SUMMARY OF INVENTION

### Technical Problem

As described above, the acceleration sensor, the gyro sensor, the geomagnetism sensor, or the like is used in the estimation of the current position within doors. In particular, when accurately estimating a current position by using the geomagnetism sensor, a geomagnetism direction also includes an error due to influence of magnetic disturbance, and thus presence or absence of the magnetic disturbance is required to be determined accurately.

Thus, the present disclosure proposes a new and improved information processing apparatus, an information processing method, and a computer program, which can accurately estimate a current position by using a result of action recognition.

### Solution to Problem

According to the present disclosure, there is provided an information processing apparatus including: an action recognition unit configured to recognize an action of a user that has a sensor by using first sensing data of the sensor; and an accuracy estimation unit configured to estimate an accuracy of second sensing data of a geomagnetism sensor on the basis of a result of action recognition of the user obtained by the action recognition unit.

According to the present disclosure, there is provided an information processing method including: recognizing an action of a user that has a sensor by using first sensing data of the sensor; and estimating an accuracy of second sensing data of a geomagnetism sensor on the basis of a result of recognition of the action of the user.

According to the present disclosure, there is provided a computer program for causing a computer to execute: recognizing an action of a user that has a sensor by using first sensing data of the sensor; and estimating an accuracy of second sensing data of a geomagnetism sensor on the basis of a result of recognition of the action of the user.

### Advantageous Effects of Invention

As described above, according to the present disclosure, a new and improved information processing apparatus, an information processing method, and a computer program, which can accurately estimate a current position by using a result of action recognition, can be provided.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an explanatory diagram illustrating an exemplary configuration of an information processing system according to a first embodiment of the present disclosure.

FIG. 2 is an explanatory diagram illustrating an exemplary function and configuration of a portable terminal 100 according to the first embodiment of the present disclosure.

FIG. 3 is an explanatory diagram illustrating an exemplary configuration of an action dictionary storage unit 122.

FIG. 4 is an explanatory diagram illustrating an exemplary function and configuration of a position estimation processing unit 130.

FIG. 5 is a flow diagram illustrating exemplary operation of a portable terminal 100 according to the first embodiment of the present disclosure.

FIG. 6 is an explanatory diagram illustrating an exemplary function and configuration of a portable terminal 100 according to a second embodiment of the present disclosure.

FIG. 7 is an explanatory diagram illustrating an exemplary function and configuration of a position estimation processing unit 130.

FIG. 8 is a flow diagram illustrating exemplary operation of a portable terminal 100 according to the second embodiment of the present disclosure.

FIG. 9 is an explanatory diagram illustrating an example of map information 300 generated by a portable terminal 100 according to the second embodiment of the present disclosure.

FIG. 10 is a flow diagram illustrating exemplary operation of a portable terminal 100 according to the second embodiment of the present disclosure.

FIG. 11 is an explanatory diagram illustrating an exemplary variant of the second embodiment of the present disclosure.

### DESCRIPTION OF EMBODIMENT(S)

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

Note that description will be made in the following order.
1. Background of Present Disclosure
2. First Embodiment of Present Disclosure
2.1. Exemplary System Configuration
2.2. Exemplary Function and Configuration
2.3. Exemplary Operation
3. Second Embodiment of Present Disclosure
3.1. Exemplary Function and Configuration
3.2. Exemplary Operation
3.3. Exemplary Variant
4. Conclusion

### 1. Background of Present Disclosure

First, the background of the present disclosure will be described, before describing an embodiment of the present disclosure.

In pedestrian dead reckoning (PDR) that acquires a traveling route such as position information and direction information of a walker, speed estimation that uses an acceleration sensor that outputs an acceleration and direction estimation that uses a gyro sensor that outputs an angular velocity are performed. For example, when estimating a direction within doors where radio waves from the GNSS satellites are difficult to reach, the position and the direction at a time point of entering into indoors, which are calculated by the GNSS, are set as an initial position and an initial direction respectively, and a traveling distance relative to the initial position and the initial direction is obtained by multiplying the number of steps derived from the acceleration obtained from the acceleration sensor by a step length, and a speed is obtained by dividing the traveling distance by the traveling time, and a direction is obtained by integrating the angular velocity obtained from the gyro sensor, in a basic configuration of the PDR.

Note that it is known that the gyro sensor has an offset error in which a zero point fluctuates depending on temperature. Also, the direction obtained by integrating the angular velocity obtained from the gyro sensor has a larger error with time.

There is a method that utilizes the direction obtained by a geomagnetism sensor in order to estimate the offset error of the gyro sensor, or in order to correct the direction that is misaligned with time. The geomagnetic direction obtained by the geomagnetism sensor does not change practically at the same site. Thus, the offset error of the gyro sensor is estimated, or the direction that is misaligned with time is corrected, by using the information of the geomagnetic direction obtained by the geomagnetism sensor.

However, the geomagnetic direction also has an error due to the influence of magnetic disturbance resulting from a high electric current, at the vicinity of a ride and a device that uses a motor that generates a high electric current, such as an electrical train, an elevator, and an escalator. Also, the geomagnetic direction also has the error due to magnetic distortion at the vicinity of a metal of a high magnetic permeability. The geomagnetic direction obtained by the geomagnetism sensor does not become an accurate direction at a site that is influenced by the magnetic disturbance. Thus, when the offset error of the gyro sensor is estimated, or the direction that is misaligned with time is corrected, by using the information of the geomagnetic direction obtained by the geomagnetism sensor, presence or absence of the magnetic disturbance needs to be determined.

A method that determines incorporation of a component other than the geomagnetism (magnetic disturbance) from an magnitude of observed magnetism, an angle of magnetic dip, and the like is proposed from past, for example, as a method that determines the presence or absence of the magnetic disturbance. However, the method proposed from the past is unable to detect the magnetic disturbance in which only an azimuth angle is misaligned while the magnitude of observed magnetism and the angle of magnetic dip do not change. In the method proposed from the past, it is possible that the magnetic disturbance is considered as being large erroneously, when the magnitude of observed magnetism becomes small but the direction is correct, such as when in a steel framed commercial building. Thus, the method that determines the incorporation of the component other than the geomagnetism, from the magnitude of observed magnetism, the angle of magnetic dip, and the like is not perfect as a method that determines the presence or absence of the magnetic disturbance. It is desirable to be able to detect the cause of the magnetic disturbance, for example a state on an iron plate or in a box, and existence of a device that is driven by a motor.

Thus, the disclosers of the present case studied a technology that can accurately acquire a traveling route such as position information and direction information of a walker within doors particularly by effectively performing detection of what can be the cause of the magnetic disturbance. Then, the disclosers of the present case have devised a technology that can effectively perform detection of what can be the cause of the magnetic disturbance, by detecting existence of what can be the cause of the magnetic disturbance by recognition of an action of a user, as described below.

In the above, the background of the present disclosure has been described. Next, an embodiment of the present disclosure will be described in detail. First, a first embodiment of the present disclosure will be described.

### 2. First Embodiment of Present Disclosure

### [2.1. Exemplary System Configuration]

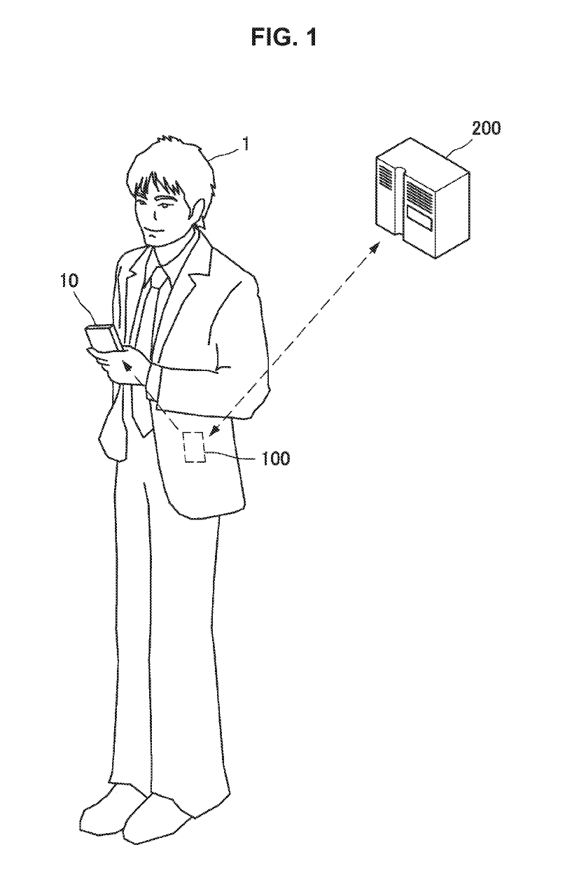

The first embodiment of the present disclosure will be described with reference to drawings. FIG. 1 is an explanatory diagram illustrating an exemplary configuration of an information processing system according to the first embodiment of the present disclosure. The information processing system illustrated in FIG. 1 measures a current position of a user 1 by using a portable terminal 100 put on by the user 1, and provides a service according to the current position, for example. In the following, the exemplary configuration of the information processing system according to the first embodiment of the present disclosure will be described by using FIG. 1.

The information processing system according to the first embodiment of the present disclosure includes the portable terminal 100 that measures the current position of the user 1 by being put on by the user 1, and a device 10 that provides the service according to the current position measured by the portable terminal 100. The portable terminal 100 is a terminal that includes sensors that measure a position and a direction, and can be an example of an information processing apparatus of the present disclosure. The portable terminal 100 can include a GNSS sensor, an acceleration sensor, a gyro sensor, a geomagnetism sensor, a barometric pressure sensor, a temperature sensor, and other sensors, for example. The portable terminal 100 may be an information processing apparatus such as a mobile phone, a highly functional mobile phone (a smartphone), a portable music player, a portable video processing device, and a tablet terminal.

The device 10 may be an information processing apparatus such as a personal computer (PC), a home video processing device (a DVD recorder, a video cassette recorder, etc.), a mobile phone, a highly functional mobile phone (a smartphone), a portable music player, a portable video processing device, a personal digital assistant (PDA), a home game machine, a portable game machine, a home electrical appliance device, and a tablet terminal, for example.

The portable terminal 100 can obtain position information and direction information by using the GNSS sensor, outside doors where the radio waves from the GNSS satellites easily reach. On the other hand, the position information and the direction information are obtained by using sensors other than the GNSS sensor, among the above sensors, for example the acceleration sensor, the gyro sensor, the geomagnetism sensor, and the like, in relation to the position and the direction at the time point of traveling into indoors as the initial position and the initial direction, within doors where it is difficult for the radio waves from the GNSS satellites to reach.

The portable terminal 100 utilizes the direction obtained by the geomagnetism sensor to estimate the offset error of the gyro sensor that is used in measuring the position and the direction within doors, or to correct the direction that is misaligned with time. As described above, the geomagnetic direction also has the error, due to the influence of the magnetic disturbance resulting from the high electric current, at the vicinity of the ride and the device that uses the motor that generates the high electric current, such as the electrical train, the elevator, and the escalator. The geomagnetic direction obtained by the geomagnetism sensor does not become an accurate direction, at a site that is influenced by the magnetic disturbance.

Thus, the portable terminal 100 according to the present embodiment recognizes the action of the user 1 that wears the portable terminal 100, by using the data (the sensing data) obtained by the sensors, and determines whether or not the user 1 is present at a site that is influenced by the magnetic disturbance, by using the recognition result. Then, the portable terminal 100 according to the present embodiment determines the reliability of the sensing data obtained by the geomagnetism sensor, on the basis of whether or not the user 1 that wears the portable terminal 100 is present at the site that is influenced by the magnetic disturbance, and estimates the offset error of the gyro sensor on the basis of the reliability. The portable terminal 100 according to the present embodiment can accurately estimate the offset error of the gyro sensor, by recognizing the action of the user 1 that wears the portable terminal 100.

The portable terminal 100 may communicate with a server device 200, through a network such as a public line network such as the Internet, a telephone line network, and a satellite communication network, as well as a dedicated line network such as various types of local area networks (LAN) that include Ethernet (registered trademark), a wide area network (WAN), and an Internet protocol-virtual private network (IP-VPN). The server device 200 can retain map information that includes information relevant to the presence or absence of the influence of the magnetic disturbance, which is described later, for example. When the server device 200 retains the map information, the portable terminal 100 determines whether or not the current position is a position that is influenced by the magnetic disturbance with reference to the map information, and can accurately estimate the offset error of the gyro sensor by using the determination result.

Note that FIG. 1 has illustrated the configuration in which the portable terminal 100 and the device 10 are different devices, but the present disclosure is not limited to such an example. The device 10 may include the sensors included in the portable terminal 100, and a function for executing the later described position estimation process.

In the above, the exemplary configuration of the information processing system according to the first embodiment of the present disclosure has been described by using FIG. 1. Next, the exemplary function and configuration of the portable terminal 100 according to the first embodiment of the present disclosure will be described.

### [2.2. Exemplary Function and Configuration]

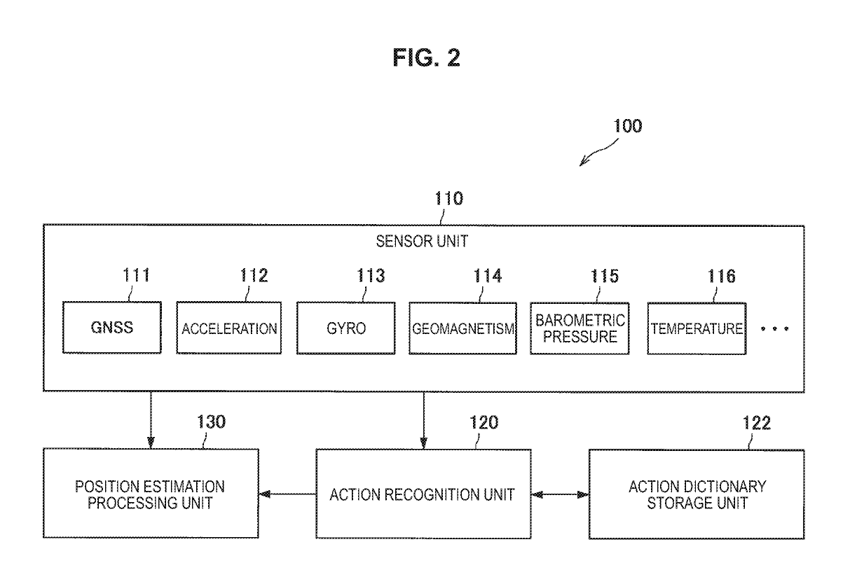

FIG. 2 is an explanatory diagram illustrating the exemplary function and configuration of the portable terminal 100 according to the first embodiment of the present disclosure. In the following, the exemplary function and configuration of the portable terminal 100 according to the first embodiment of the present disclosure will be described.

As described above, the portable terminal 100 measures the current position of the user 1 by being put on by the user 1. As illustrated in FIG. 2, the portable terminal 100 according to the first embodiment of the present disclosure includes a sensor unit 110, an action recognition unit 120, an action dictionary storage unit 122, and a position estimation processing unit 130.

The sensor unit 110 outputs the sensing data according to the motion and the orientation of the portable terminal 100, and the environment around the portable terminal 100. The sensor unit 110 includes a GNSS sensor 111, an acceleration sensor 112, a gyro sensor 113, a geomagnetism sensor 114, a barometric pressure sensor 115, a temperature sensor 116, and the like, for example.

The GNSS sensor 111 is a sensor that measures the current position by means of the radio waves transmitted from the GNSS satellites. The GNSS sensor 111 can include what uses global positioning system (GPS), what uses global navigation satellite system (GLONASS), what uses Beidou, and the like, for example. The acceleration sensor 112 is a sensor that outputs the information of the acceleration as the sensing data. The gyro sensor 113 is a sensor that outputs the information of the angular velocity as the sensing data. The geomagnetism sensor 114 is a sensor that outputs the magnitude and the direction of the magnetic field (the magnetic field) as the sensing data. The barometric pressure sensor 115 is a sensor that outputs the information of the barometric pressure as the sensing data. The temperature sensor 116 is a sensor that outputs the information of the temperature as the sensing data.

Each of the sensors that compose the sensor unit 110 is not limited to a specific sensor if the sensor outputs the information described above as the sensing data. Also, the sensors that compose the sensor unit 110 are not limited to the above ones. A microphone that collects sound and a camera that captures an image can also be included, as the sensors that compose the sensor unit 110, for example. Also, a device that performs indoor positioning by means of a wireless LAN can be included, as the sensors that compose the sensor unit 110.

The action recognition unit 120 executes a process for recognizing the action of the user 1 that puts on the portable terminal 100, by using the sensing data output by the sensor unit 110. The action recognition unit 120 may refer to a behavior model stored in the action dictionary storage unit 122, when recognizing the action of the user 1 that puts on the portable terminal 100, by using the sensing data output by the sensor unit 110. Also, the action recognition unit 120 may use the sensing data of a predetermined period, for example the last approximately 1 second, when executing the process for recognizing the action of the user 1 that puts on the portable terminal 100.

When the process for recognizing the action of the user 1 by the action recognition unit 120 is executed, the action dictionary storage unit 122 stores the behavior model that is referred by the action recognition unit 120. The behavior model stored by the action dictionary storage unit 122 is roughly classified into the behavior model that can be the cause of the magnetic disturbance of the geomagnetism and the behavior model that cannot be the cause of the magnetic disturbance of the geomagnetism. The behavior model that can be the cause of the magnetic disturbance of the geomagnetism can include a behavior of riding the device that is driven by the motor, for example a behavior model of elevator, a behavior model of escalator, a behavior model of car and electrical train, and the like. The behavior model that cannot be the cause of the magnetic disturbance of the geomagnetism can include a behavior model of stair steps, a behavior model of bicycle, a behavior model of walk, and the like, for example.

The action recognition unit 120 compares the sensing data output by the sensor unit 110 and the behavior model stored by the action dictionary storage unit 122. Then, the action recognition unit 120 recognizes what action the user 1 that puts on the portable terminal 100 performs, from the result of comparison between the sensing data output by the sensor unit 110 and the behavior model stored by the action dictionary storage unit 122. The action recognition unit 120 outputs the result of the action recognition of the user 1 to the position estimation processing unit 130. The action recognition unit 120 may output the information with respect to the action itself, as the result of the action recognition of the user 1, and may output the information with respect to whether the action can be the cause of the magnetic disturbance, such as the state of being on an iron plate or in a box and the state at the vicinity of the device that is driven by the motor, or whether the action cannot be the cause of the magnetic disturbance.

The action recognition unit 120 may use the sensing data of a predetermined period, when executing the process for recognizing the action of the user 1 that puts on the portable terminal 100, as described above. The action recognition unit 120 can recognize the action of the user 1 by analyzing the sensing data of the predetermined period. For example, if the barometric pressure rises (or drops) by a predetermined value or more in a predetermined time, as a result of analysis of the value of the barometric pressure sensor 115, the action recognition unit 120 can determine that the user 1 that puts on the portable terminal 100 rides an elevator, for example. Conversely, if the barometric pressure rises (or drops) by a predetermined value or more in a predetermined time, as the result of the analysis of the value of the barometric pressure sensor 115, the action recognition unit 120 can exclude, from candidates, the action of the user 1 riding the elevator, at the time of the action recognition of the user 1 that puts on the portable terminal 100.

The action recognition unit 120 may acquire the situation of the radio wave of Wi-Fi for example, as the sensing data. If a frequent change in the radio wave intensity of Wi-Fi or the access point of the connection destination is detected, as a result of acquisition of the situation of the radio wave of Wi-Fi, the action recognition unit 120 can determine that the user 1 that puts on the portable terminal 100 travels at a high speed, for example. Conversely, if the radio wave intensity of Wi-Fi and the access point of the connection destination do not change frequently, the action recognition unit 120 can exclude the action of the user 1 traveling at a high speed, from the candidates, at the time of the action recognition of the user 1 that puts on the portable terminal 100.

The action recognition process by the action recognition unit 120 is not limited to a specific method. The action recognition unit 120 employs the technology relevant to the action recognition process disclosed in JP 2014-56585A for example, in order to perform the action recognition of the user 1 that puts on the portable terminal 100, which uses the sensing data output by the sensor unit 110.

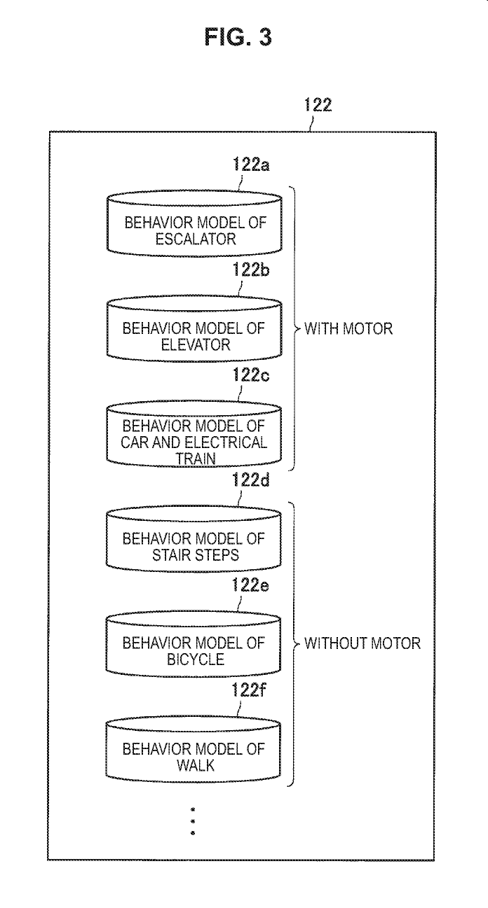

FIG. 3 is an explanatory diagram illustrating the exemplary configuration of the action dictionary storage unit 122. In the present embodiment, the action dictionary storage unit 122 includes a behavior model of escalator 122a, a behavior model of elevator 122b, a behavior model of car and electrical train 122c, a behavior model of stair steps 122d, a behavior model of bicycle 122e, and a behavior model of walk 122f.

The action recognition unit 120 recognizes what action the user 1 that puts on the portable terminal 100 performs, by checking the sensing data output by the sensor unit 110, against each behavior model stored in the action dictionary storage unit 122, which are illustrated in FIG. 3. Note that the action recognition unit 120 may calculate and output an execution probability of each action of the user 1, when not being able to uniquely decide what action the user 1 that puts on the portable terminal 100 performs, as the result of checking the sensing data output by the sensor unit 110 against each behavior model stored in the action dictionary storage unit 122.

Note that, in the present embodiment, the action dictionary storage unit 122 is included in the portable terminal 100, but the present disclosure is not limited to such an example. The action dictionary storage unit 122 may be included in the server device 200 illustrated in FIG. 1, for example. When the action dictionary storage unit 122 is included in the server device 200, the action recognition unit 120 executes the check against the behavior models stored in the action dictionary storage unit 122, by performing communication with the server device 200.

The position estimation processing unit 130 executes a process for estimating the position and the direction of the portable terminal 100. The position estimation processing unit 130 estimates the position and the direction of the portable terminal 100 by using the GNSS sensor, outside doors where the radio waves from the GNSS satellites easily reach. On the other hand, the position estimation processing unit 130 estimates the position and the direction of the portable terminal 100 by using the sensing data output by the sensor unit 110, in relation to the position and the direction at the time point of traveling into indoors as the initial position and the initial direction, within doors where it is difficult for the radio waves from the GNSS satellites to reach. The position estimation processing unit 130 estimates the direction of the portable terminal 100 by using the sensing data output by the gyro sensor 113, particularly. Note that whether or not the portable terminal 100 has traveled into indoors can be determined on the basis of whether or not the intensity of the radio waves from the GNSS satellites has become equal to or smaller than a predetermined threshold value, for example.

As described above, the direction obtained by the sensing data output by the geomagnetism sensor 114 is utilized to estimate the offset error of the gyro sensor 113 that is used in measuring the position and the direction within doors, or to correct the direction that is misaligned with time. However, as described above, the geomagnetic direction also has an error due to the influence of the magnetic disturbance resulting from the high electric current, at the vicinity of the ride and the device that uses the motor that generates the high electric current, such as the electrical train, the elevator, and the escalator. Moreover, electric current flows in rails on which the electrical train travels, and the geomagnetic direction also has an error in a state of riding the electrical train and a state of being close to the rails. At a site that is influenced by the magnetic disturbance, the geomagnetic direction obtained by the sensing data output by the geomagnetism sensor 114 does not become an accurate direction.

The position estimation processing unit 130 determines whether or not the user 1 is present at the site that is influenced by the magnetic disturbance, by using the recognition result of the action recognition unit 120. Then, the position estimation processing unit 130 determines whether or not the user 1 that wears the portable terminal 100 is present at the site that is influenced by the magnetic disturbance from the recognition result of the action recognition unit 120, and determines the reliability of the sensing data obtained by the geomagnetism sensor 114, and estimates the offset error of the gyro sensor 113 on the basis of the reliability. The position estimation processing unit 130 can accurately estimate the offset error of the gyro sensor 113, by using the recognition result of the action recognition unit 120.

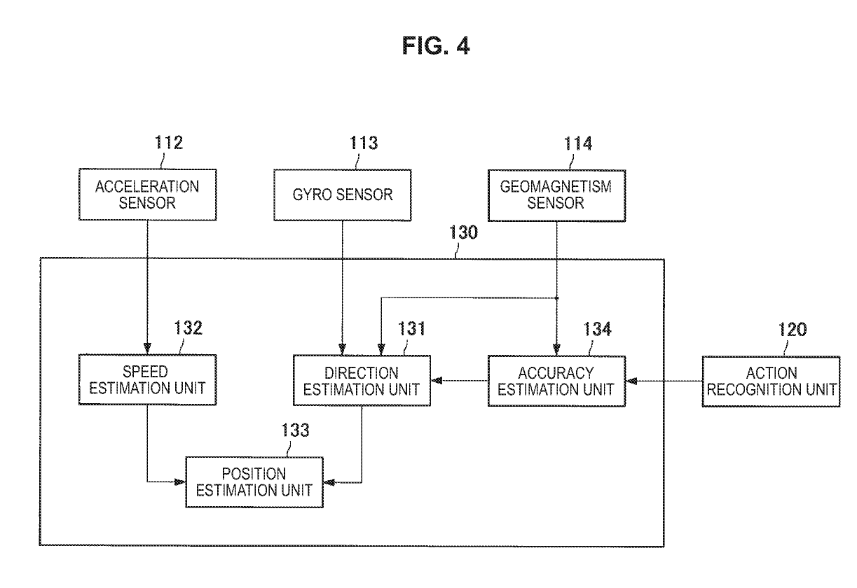

FIG. 4 is an explanatory diagram illustrating the exemplary function and configuration of the position estimation processing unit 130. The position estimation processing unit 130 illustrated in FIG. 4 executes the process for estimating the position and the direction of the portable terminal 100, by using the sensing data output from the acceleration sensor 112, the gyro sensor 113, the geomagnetism sensor 114 mainly. As a matter of course, the position estimation processing unit 130 may execute the process for estimating the position and the direction of the portable terminal 100, by using the sensing data output from sensors other than the acceleration sensor 112, the gyro sensor 113, and the geomagnetism sensor 114, which are illustrated in FIG. 4. As illustrated in FIG. 4, the position estimation processing unit 130 includes a direction estimation unit 131, a speed estimation unit 132, a position estimation unit 133, and an accuracy estimation unit 134.

The direction estimation unit 131 estimates the direction of the portable terminal 100, by using the sensing data output from the gyro sensor 113. The direction estimation unit 131 estimates the direction of the portable terminal 100 by integrating the angular velocity obtained from the gyro sensor 113, in relation to the direction at the time point of traveling into indoors as the initial direction.

As described above, the gyro sensor 113 has the offset error in which the zero point fluctuates due to the temperature. Also, the direction obtained by integrating the angular velocity obtained from the gyro sensor 113 has a large error with time. Thus, the direction estimation unit 131 utilizes the direction obtained by the sensing data output by the geomagnetism sensor 114, in order to estimate the offset error of the gyro sensor 113, or to correct the direction that is misaligned with time.

The direction estimation unit 131 may estimate the offset error of the gyro sensor 113, or correct the direction that is misaligned with time, at an arbitrary timing. For example, the direction estimation unit 131 may estimate the offset error of the gyro sensor 113, or correct the direction that is misaligned with time, at predetermined time intervals.

Also, the direction estimation unit 131 may estimate the offset error of the gyro sensor 113 when the temperature change occurs by a predetermined value or more. As described above, the gyro sensor 113 has the offset error in which the zero point fluctuates due to the temperature. Thus, it may be such that the offset error of the gyro sensor 113 is not estimated when the temperature change does not occur, and the offset error of the gyro sensor 113 is estimated when the temperature change occurs by a predetermined value or more. Then, when estimating the offset error of the gyro sensor 113, or correcting the direction that is misaligned with time, the direction estimation unit 131 performs these estimation and correction, on the basis of the information relevant to the accuracy of the geomagnetism sensor 114, which is output from the accuracy estimation unit 134.

The speed estimation unit 132 estimates the speed of the portable terminal 100, by using the sensing data output from the acceleration sensor 112. The traveling distance of the user 1 that has the portable terminal 100 is obtained, by multiplying the number of steps derived from the acceleration obtained by the sensing data output from the acceleration sensor 112 by the step length. The speed estimation unit 132 derives the traveling distance of the user 1 that has the portable terminal 100 from the acceleration obtained from the acceleration sensor 112 as described above, and estimates the speed of the portable terminal 100 by dividing the traveling distance by the time for traveling the traveling distance.

The position estimation unit 133 estimates the position of the portable terminal 100. Within doors where it is difficult for the radio waves from the GNSS satellites to reach, the position estimation unit 133 estimates the current position of the portable terminal 100, in relation to the position and the direction at the time point of traveling into indoors as the initial position and the initial direction, by using the information of the direction of the portable terminal 100 estimated by the direction estimation unit 131 and the information of the speed of the portable terminal 100 estimated by the speed estimation unit 132. The position estimation unit 133 acquires the information of the direction of the portable terminal 100 estimated by the direction estimation unit 131 and the information of the speed of the portable terminal 100 estimated by the speed estimation unit 132, periodically, at a predetermined timing, for example at predetermined intervals. If the information of the direction and the information of the speed of the portable terminal 100 are known, the position estimation unit 133 can derive the information of the current position of the portable terminal 100, from the estimated position of the last time.

The accuracy estimation unit 134 estimates the accuracy of the direction obtained by the sensing data output by the geomagnetism sensor 114, by using the recognition result of the action recognition unit 120. The direction estimation unit 131 uses the direction obtained by the sensing data output by the geomagnetism sensor 114, in order to estimate the offset error of the gyro sensor 113, or to correct the direction that is misaligned with time. However, the geomagnetic direction obtained by the sensing data output by the geomagnetism sensor 114 does not become an accurate direction, at the site that is influenced by the magnetic disturbance. Thus, the accuracy estimation unit 134 determines whether or not the site is influenced by the magnetic disturbance, by using the recognition result of the action recognition unit 120, and estimates the accuracy of the direction obtained by the sensing data output by the geomagnetism sensor 114.

For example, when the recognition result of the action recognition unit 120 indicates that the user 1 that wears the portable terminal 100 is in a state that is influenced by the magnetic disturbance, such as boarding the elevator, the escalator, and the electrical train, the accuracy estimation unit 134 estimates that the accuracy of the direction obtained by the sensing data output by the geomagnetism sensor 114 is not good at the current site. On the other hand, when the recognition result of the action recognition unit 120 indicates that the user 1 that wears the portable terminal 100 is in a state that is not influenced by the magnetic disturbance, such as walking, ascending and descending stair steps, and riding a bicycle, the accuracy estimation unit 134 estimates that the accuracy of the direction obtained by the sensing data output by the geomagnetism sensor 114 is good at the current site.

The accuracy estimation unit 134 outputs the result of the estimation to the direction estimation unit 131, upon estimating the accuracy of the direction obtained by the sensing data output by the geomagnetism sensor 114, by using the recognition result of the action recognition unit 120. The direction estimation unit 131 executes the process for estimating the offset error of the gyro sensor 113 or correcting the direction that is misaligned with time, on the basis of the estimation result of the accuracy of the direction obtained by the sensing data output by the geomagnetism sensor 114, which is output by the accuracy estimation unit 134.

The accuracy estimation unit 134 may output a binary value indicating that the accuracy is good or bad, or output predetermined weight, as the estimation result of the direction obtained by the sensing data output by the geomagnetism sensor 114. In the case that the accuracy estimation unit 134 outputs the estimation result as the binary value indicating that the accuracy is good or bad, the direction estimation unit 131 performs the above estimation and correction by using the direction obtained by the sensing data output by the geomagnetism sensor 114 when the accuracy estimation unit 134 outputs the estimation result indicating good accuracy, and does not use the direction obtained by the sensing data output by the geomagnetism sensor 114 when the accuracy estimation unit 134 outputs the estimation result indicating bad accuracy. When the accuracy estimation unit 134 outputs the estimation result with predetermined weight, the direction estimation unit 131 may perform the above estimation and correction by using the direction obtained by the sensing data output by the geomagnetism sensor 114, on the basis of the weight.

The accuracy estimation unit 134 may change the weight by using the information such as the amount of change in the temperature obtained by, the sensing data output by the sensor unit 110 and elapsed time, when outputting the weight as the estimation result of the direction obtained by the sensing data output by the geomagnetism sensor 114. That is, the possibility that the gyro sensor 113 has the offset error becomes higher as the amount of change in the temperature becomes larger, and thus the accuracy estimation unit 134 may change the weight to make the accuracy worse. Also, the possibility that the misalignment occurs in the information of the direction obtained by integrating the value from the gyro sensor 113 becomes higher as the time elapses, and thus the accuracy estimation unit 134 may change the weight to make the accuracy worse.

When the execution probability of each action is output as the recognition result of the action recognition unit 120, the accuracy estimation unit 134 may estimate the accuracy of the direction obtained by the sensing data output by the geomagnetism sensor 114, on the basis of the execution probability of the entire action that belongs to a certain group, for example the entire action that is influenced by the magnetic disturbance.

The portable terminal 100 according to the first embodiment of the present disclosure has the configuration illustrated in FIGS. 2 to 4, and thereby can estimate the offset error of the gyro sensor 113, or correct the direction that is misaligned with time, on the basis of the sensing data output by the geomagnetism sensor 114. Then, the portable terminal 100 according to the first embodiment of the present disclosure has the configuration illustrated in FIGS. 2 to 4, and thereby can estimate the accuracy of the direction obtained by the sensing data output by the geomagnetism sensor 114, by using the recognition result of the action recognition unit 120, in order to estimate the offset error of the gyro sensor 113 or correct the direction that is misaligned with time, by using the estimation result of the accuracy.

In the above, the exemplary function and configuration of the portable terminal 100 according to the first embodiment of the present disclosure has been described. Next, the exemplary operation of the portable terminal 100 according to the first embodiment of the present disclosure will be described.

### [2.3. Exemplary Operation]

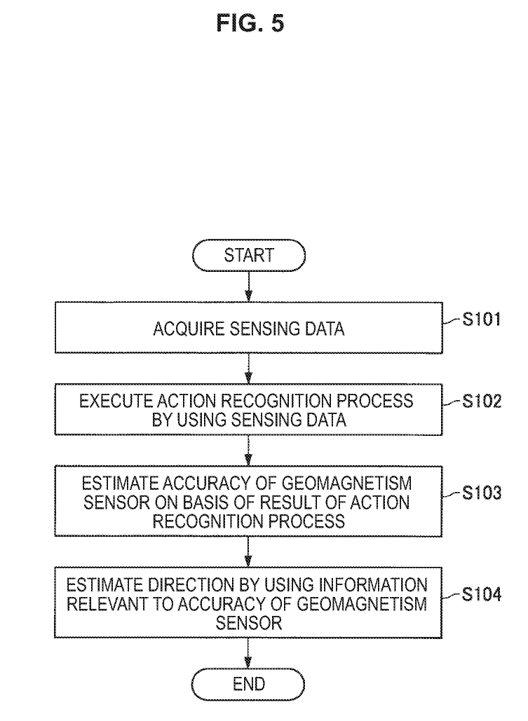

FIG. 5 is a flow diagram illustrating exemplary operation of the portable terminal 100 according to the first embodiment of the present disclosure. FIG. 5 illustrates the exemplary operation of the portable terminal 100 according to the first embodiment of the present disclosure, when recognizing the action of the user 1 that wears the portable terminal 100 in order to estimate the offset error of the gyro sensor 113 or to correct the direction that is misaligned with time on the basis of the recognition result. In the following, the exemplary operation of the portable terminal 100 according to the first embodiment of the present disclosure will be described by using FIG. 5.

The portable terminal 100 first acquires the sensing data output by the sensor unit 110, when recognizing the action of the user 1 that wears the portable terminal 100 in order to estimate the offset error of the gyro sensor 113 or correct the direction that is misaligned with time on the basis of the recognition result (step S101). The action recognition unit 120 can perform the acquisition of the sensing data output by the portable terminal 100, of step S101, for example.

Upon acquiring the sensing data output by the sensor unit 110 in the above step S101, the portable terminal 100 subsequently executes the action recognition process of the user 1 that wears the portable terminal 100, by using the acquired sensing data (step S102). The action recognition unit 120 can perform the execution of the action recognition process of the user 1 that wears the portable terminal 100, of step S102, for example.

As described above, the action recognition process by the action recognition unit 120 is not limited to a specific method. The action recognition unit 120 employs the technology relevant to the action recognition process disclosed in JP 2014-56585A for example, in order to perform the action recognition of the user 1 that puts on the portable terminal 100, which uses the sensing data output by the sensor unit 110.

Upon executing the action recognition process of the user 1 that wears the portable terminal 100 which uses the sensing data output by the sensor unit 110 in the above step S102, the portable terminal 100 subsequently estimates the accuracy of the direction obtained by the sensing data output by the geomagnetism sensor 114, on the basis of the result of the action recognition process in the above step S102 (step S103). The accuracy estimation unit 134 can execute the estimation process of the accuracy of the geomagnetism sensor 114 of step S103, for example.

The estimation process of the accuracy of the direction obtained by the sensing data output by the geomagnetism sensor 114 in the above step S103 is performed by using the result of the action recognition process in the above step S102. The estimation process of the accuracy in the above step S103 is performed by determining whether or not the user 1 that wears the portable terminal 100 is present at the site that is influenced by the magnetic disturbance, by using the result of the action recognition process in the above step S102, and estimating the accuracy of the direction obtained by the sensing data output by the geomagnetism sensor 114.

For example, if the result of the action recognition process in the above step S102 indicates that the user 1 that wears the portable terminal 100 is in a state that is influenced by the magnetic disturbance, such as boarding the elevator, the escalator, the electrical train, the accuracy of the direction obtained by the sensing data output by the geomagnetism sensor 114 is estimated to be not good at the current site, in the estimation process of the accuracy in the above step S103. On the other hand, if the result of the action recognition process in the above step S102 indicates that the user 1 that wears the portable terminal 100 is in a state that is not influenced by the magnetic disturbance, such as walking, ascending and descending the stair steps, riding the bicycle, the accuracy of the direction obtained by the sensing data output by the geomagnetism sensor 114 is estimated to be good at the current site, in the estimation process of the accuracy in the above step S103.

In the above step S103, upon estimating the accuracy of the direction obtained by the sensing data output by the geomagnetism sensor 114, the portable terminal 100 subsequently estimates the direction of the portable terminal 100, by using the information relevant to the accuracy of the direction obtained by the sensing data output by the geomagnetism sensor 114 (step S104). The direction estimation unit 131 can execute the process for estimating the direction of the portable terminal 100, of step S104, for example.

In the above step S103, if the accuracy of the direction obtained by the sensing data output by the geomagnetism sensor 114 is estimated to be not good at the current site, the direction of the portable terminal 100 is estimated, without using the sensing data output by the geomagnetism sensor 114, or with reduced weight even when the sensing data output by the geomagnetism sensor 114 is used, in the above step S104. On the other hand, if the accuracy of the direction obtained by the sensing data output by the geomagnetism sensor 114 is estimated to be good at the current site in the above step S103, the direction of the portable terminal 100 is estimated, using the sensing data output by the geomagnetism sensor 114, or with increased weight, in the above step S104.

The portable terminal 100 according to the first embodiment of the present disclosure can estimate the offset error of the gyro sensor 113, or correct the direction that is misaligned with time, on the basis of the sensing data output by the geomagnetism sensor 114, by executing the behavior illustrated in FIG. 5. Then, the portable terminal 100 according to the first embodiment of the present disclosure can estimate the accuracy of the direction obtained by the sensing data output by the geomagnetism sensor 114, by using the result of the action recognition process of the user 1 which uses the sensing data output by the sensor unit 110, by executing the behavior illustrated in FIG. 5, in order to estimate the offset error of the gyro sensor 113, or to correct the direction that is misaligned with time, by using the estimation result of the accuracy.

In the above, the first embodiment of the present disclosure has been described. Next, a second embodiment of the present disclosure will be described.

### 3. Second Embodiment of Present Disclosure

The first embodiment of the above present disclosure has estimated the accuracy of the direction obtained by the sensing data output by the geomagnetism sensor 114, by using the result of the action recognition process of the user 1 which uses the sensing data output by the sensor unit 110.

In the second embodiment of the present disclosure described below, a technology that creates a map that can determine the presence or absence of the influence of the magnetic disturbance by using the result of the action recognition process of the user 1 which uses the sensing data output by the sensor unit 110 will be described. The second embodiment of the present disclosure can estimate the accuracy of the direction obtained by the sensing data output by the geomagnetism sensor 114 by creating and referring to the map that can determine the presence or absence of the influence of the magnetic disturbance by using the result of the action recognition process of the user 1.

### [3.1. Exemplary Function and Configuration]

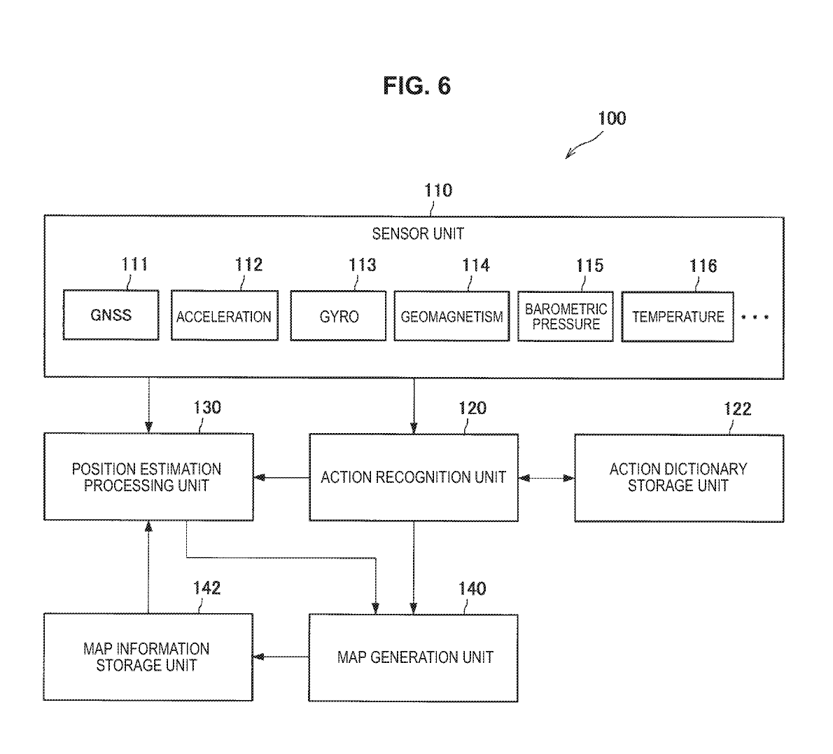

FIG. 6 is an explanatory diagram illustrating the exemplary function and configuration of the portable terminal 100 according to the second embodiment of the present disclosure. In the following, the exemplary function and configuration of the portable terminal 100 according to the second embodiment of the present disclosure will be described.

As described above, the portable terminal 100 measures the current position of the user 1 by being put on by the user 1. As illustrated in FIG. 6, the portable terminal 100 according to the second embodiment of the present disclosure includes a sensor unit 110, an action recognition unit 120, an action dictionary storage unit 122, a position estimation processing unit 130, a map generation unit 140, and a map information storage unit 142.

The portable terminal 100 according to the second embodiment of the present disclosure illustrated in FIG. 6 is the portable terminal 100 according to the first embodiment of the present disclosure illustrated in FIG. 2 to which the map generation unit 140 and the map information storage unit 142 are added. Thus, in the following, the map generation unit 140 and the map information storage unit 142 newly added to the second embodiment will be described in detail.

The map generation unit 140 generates map information in which the result of the action recognition of the user 1 that puts on the portable terminal 100 by the action recognition unit 120 and the estimation result of the current position by the position estimation processing unit 130 are associated. The map generation unit 140 stores the map information in the map information storage unit 142, upon generating the map information in which the result of the action recognition of the user 1 that puts on the portable terminal 100 by the action recognition unit 120 and the estimation result of the current position by the position estimation processing unit 130 are associated.

For example, if it is detected that the user 1 performs the action that receives the influence of the magnetic disturbance, such as riding the elevator or the escalator, as the result of the action recognition of the user 1 by the action recognition unit 120, the map generation unit 140 generates the map information in which the action that receives the influence of the magnetic disturbance, which is being performed, is associated with the site, as the result of the action recognition of the user 1.

The map information storage unit 142 stores the map information generated by the map generation unit 140. The map information stored in the map information storage unit 142 is referred by the position estimation processing unit 130, and is used in the estimation process of the accuracy of the direction obtained by the sensing data output by the geomagnetism sensor 114, by the position estimation processing unit 130.

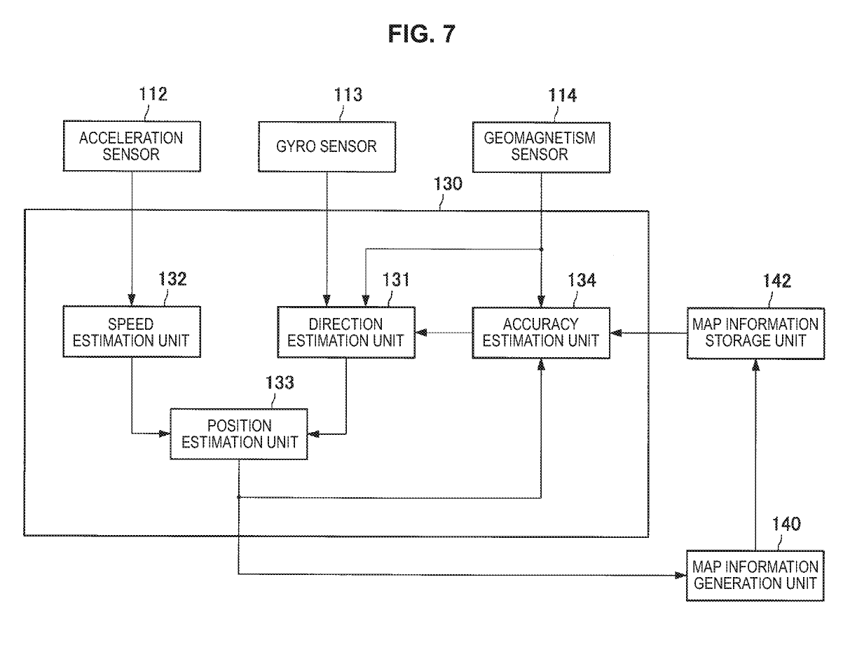

FIG. 7 is an explanatory diagram illustrating the exemplary function and configuration of the position estimation processing unit 130. The position estimation processing unit 130 illustrated in FIG. 7 is the same as the configuration of the position estimation processing unit 130 illustrated in FIG. 4, and executes the process for estimating the position and the direction of the portable terminal 100, by using the sensing data output from the acceleration sensor 112, the gyro sensor 113, and the geomagnetism sensor 114 mainly.

The position estimation unit 133, which has estimated the current position of the portable terminal 100 on the basis of the direction estimated by the direction estimation unit 131 and the speed estimated by the speed estimation unit 132, passes the information of the estimated current position to the map generation unit 140. The map generation unit 140 generates the map information, associating the result of the action recognition of the user 1 that puts on the portable terminal 100 by the action recognition unit 120 at the position, with the information of the current position estimated by the position estimation unit 133. Then, the map generation unit 140 stores the generated map information in the map information storage unit 142.

Then, the accuracy estimation unit 134 estimates the accuracy of the direction obtained by the sensing data output by the geomagnetism sensor 114, at the position of the portable terminal 100 estimated by the position estimation unit 133, by using the map information stored in the map information storage unit 142.

The portable terminal 100 according to the second embodiment of the present disclosure can determine the presence or absence of the influence of the magnetic disturbance, even without performing the action recognition process by the action recognition unit 120, by using the map information stored in the map information storage unit 142. Then, the portable terminal 100 according to the second embodiment of the present disclosure estimates the accuracy of the direction obtained by the sensing data output by the geomagnetism sensor 114, by using the map information stored in the map information storage unit 142, in order to estimate the offset error of the gyro sensor 113, or to correct the direction that is misaligned with time, by using the estimation result of the accuracy.

In the above, the exemplary function and configuration of the portable terminal 100 according to the second embodiment of the present disclosure has been described. Next, exemplary operation of the portable terminal 100 according to the second embodiment of the present disclosure will be described.

### [3.2. Exemplary Operation]

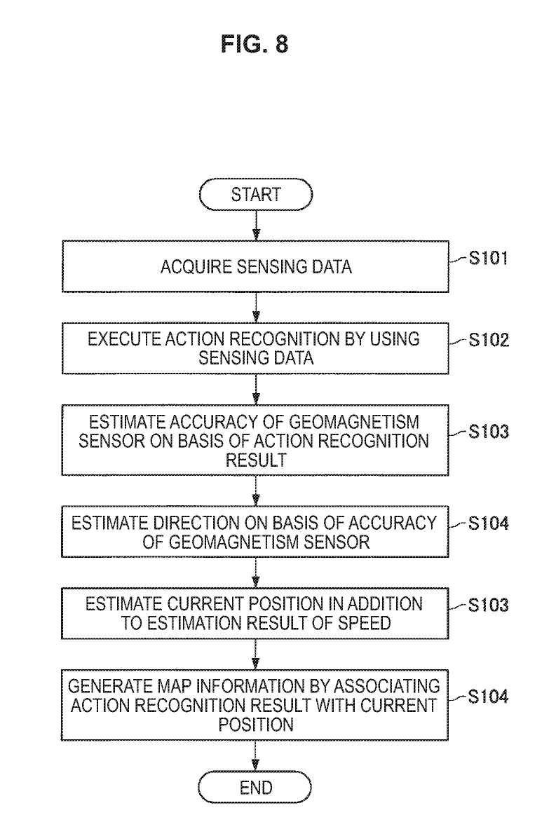

FIG. 8 is a flow diagram illustrating the exemplary operation of the portable terminal 100 according to the second embodiment of the present disclosure. FIG. 8 illustrates the exemplary operation of the portable terminal 100 according to the second embodiment of the present disclosure, when recognizing the action of the user 1 that wears the portable terminal 100, and creating the map that can determine the presence or absence of the influence of the magnetic disturbance on the basis of the recognition result. In the following, the exemplary operation of the portable terminal 100 according to the second embodiment of the present disclosure will be described by using FIG. 8.

The portable terminal 100 first acquires the sensing data output by the sensor unit 110, when recognizing the action of the user 1 that wears the portable terminal 100 in order to estimate the offset error of the gyro sensor 113 or correct the direction that is misaligned with time on the basis of the recognition result (step S111). The action recognition unit 120 can perform the acquisition of the sensing data output by the portable terminal 100, of step S111, for example.

When acquiring the sensing data output by the sensor unit 110 in the above step S111, the portable terminal 100 subsequently executes the action recognition process of the user 1 that wears the portable terminal 100, by using the acquired sensing data (step S112). The action recognition unit 120 can perform the execution of the action recognition process of the user 1 that wears the portable terminal 100, of step S112, for example.

As described above, the action recognition process by the action recognition unit 120 is not limited to a specific method. The action recognition unit 120 employs the technology relevant to the action recognition process disclosed in JP 2014-56585A for example, in order to perform the action recognition of the user 1 that puts on the portable terminal 100, which uses the sensing data output by the sensor unit 110.

Upon executing the action recognition process of the user 1 that wears the portable terminal 100 which uses the sensing data output by the sensor unit 110 in the above step S112, the portable terminal 100 subsequently estimates the accuracy of the direction obtained by the sensing data output by the geomagnetism sensor 114, on the basis of the result of the action recognition process in the above step S112 (step S113). The accuracy estimation unit 134 can execute the estimation process of the accuracy of the geomagnetism sensor 114 of step S103, for example.

The estimation process of the accuracy of the direction obtained by the sensing data output by the geomagnetism sensor 114 in the above step S113 is performed by using the result of the action recognition process in the above step S112. The estimation process of the accuracy in the above step S113 is performed by determining whether or not the user 1 that wears the portable terminal 100 is present at the site that is influenced by the magnetic disturbance, by using the result of the action recognition process in the above step S112, and estimating the accuracy of the direction obtained by the sensing data output by the geomagnetism sensor 114.

Upon estimating the accuracy of the direction obtained by the sensing data output by the geomagnetism sensor 114 in the above step S113, the portable terminal 100 subsequently estimates the direction of the portable terminal 100, by using the information relevant to the accuracy of the direction obtained by the sensing data output by the geomagnetism sensor 114 (step S114). The direction estimation unit 131 can execute the process for estimating the direction of the portable terminal 100, of step S114, for example.

Upon estimating the direction of the portable terminal 100 in the above step S114, the portable terminal 100 subsequently estimates the current position of the portable terminal 100, in addition to the information of the estimated direction, and the estimation result of the speed of the portable terminal 100 which uses the sensing data output from the acceleration sensor 112 (step S115). The position estimation unit 133 can execute the process for estimating the current position of the portable terminal 100, of step S115, for example. The portable terminal 100 acquires the information of the direction of the portable terminal 100 and the information of the speed of the portable terminal 100 at a predetermined timing, for example periodically at predetermined intervals. If the information of the direction and the information of the speed of the portable terminal 100 are detected, the information of the current position of the portable terminal 100 can be derived from the estimated position of the last time, in step S115.

Upon estimating the current position of the portable terminal 100 in the above step S115, the portable terminal 100 subsequently associates the result of the action recognition process in the above step S112 with the estimated current position, in order to generate the map information (step S116). The map generation unit 140 can execute the generation process of the map information of step S116, for example.

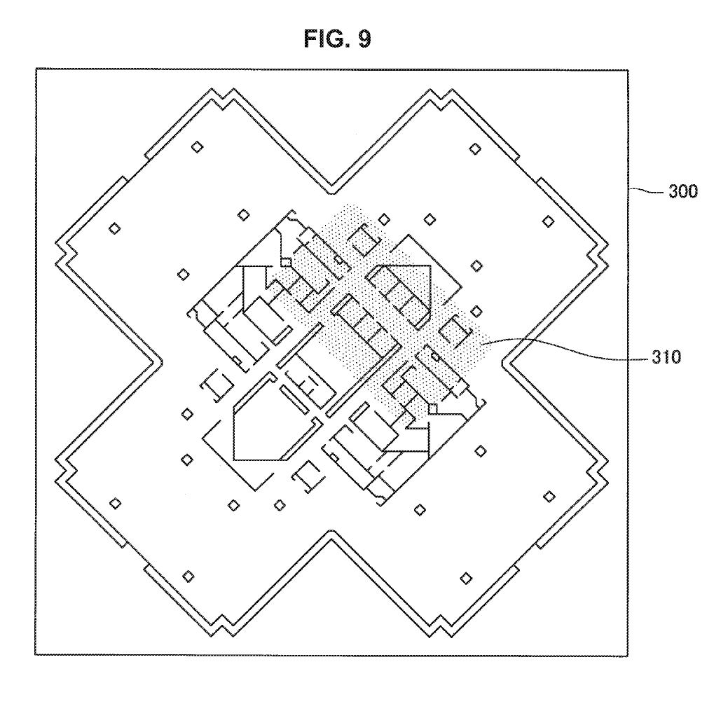

FIG. 9 is an explanatory diagram illustrating an example of the map information 300 generated by the portable terminal 100 according to the second embodiment of the present disclosure. FIG. 9 illustrates map information 300 in which a region 310 that is influenced by the magnetic disturbance, which is derived from the result of the action recognition process, is illustrated in an area where the user 1 that puts on the portable terminal 100 performs action (for example, a predetermined floor of a commercial building). The region 310 can be generated by accumulating the information of the site where it is determined that there is the influence of the magnetic disturbance, from the result of the action recognition process. The portable terminal 100 can use the map information 300 in the estimation of the accuracy of the direction obtained by the sensing data output by the geomagnetism sensor 114, by generating the map information 300 illustrated in FIG. 9.

It is needless to say that the map information 300 generated by the portable terminal 100 according to the second embodiment of the present disclosure is not limited to the one that illustrates the region 310 where there is the influence of the magnetic disturbance as illustrated in FIG. 9.

The map information 300 generated by the portable terminal 100 according to the second embodiment of the present disclosure may indicate the site where it is determined that there is the influence of the magnetic disturbance from the result of the action recognition process, with pinpoint accuracy, for example. When the site where it is determined that there is the influence of the magnetic disturbance is indicated with pinpoint accuracy, the portable terminal 100 according to the second embodiment of the present disclosure may determine that there is the influence of the magnetic disturbance within a predetermined area surrounding the site where it is determined that there is the influence of the magnetic disturbance, when performing the estimation of the offset error of the gyro sensor 113 and the correction of the direction, which are described later.

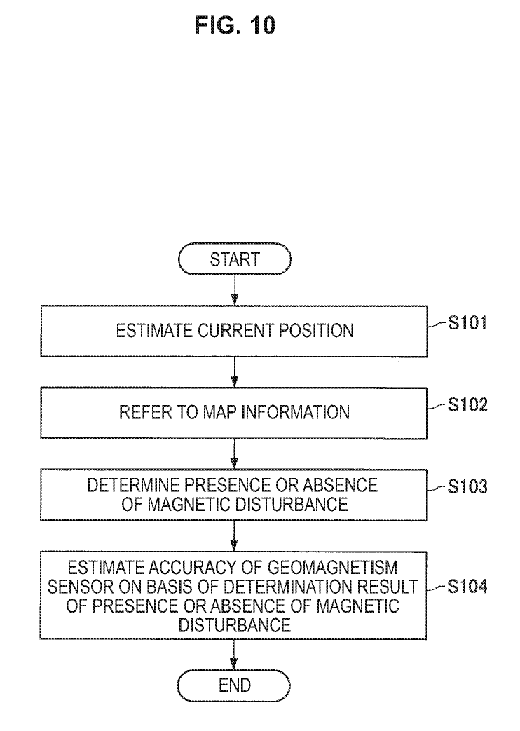

FIG. 10 is a flow diagram illustrating the exemplary operation of the portable terminal 100 according to the second embodiment of the present disclosure. FIG. 10 illustrates the exemplary operation of the portable terminal 100 according to the second embodiment of the present disclosure, when estimating the offset error of the gyro sensor 113, or correcting the direction that is misaligned with time, on the basis of the map information that can determine the presence or absence of the influence of the magnetic disturbance. In the following, the exemplary operation of the portable terminal 100 according to the second embodiment of the present disclosure will be described by using FIG. 10.

When performing the estimation of the offset error of the gyro sensor 113 and the correction of the direction on the basis of the map information, the portable terminal 100 first estimates the current position of the portable terminal 100, in addition to the information of the estimated direction and the estimation result of the speed of the portable terminal 100 which uses the sensing data output from the acceleration sensor 112 (step S121). The position estimation unit 133 can execute the process for estimating the current position of the portable terminal 100, of step S121, for example.

Upon estimating the current position of the portable terminal 100 in the above step S121, the portable terminal 100 subsequently refers to the map information that can determine the presence or absence of the influence of the magnetic disturbance, which is stored in the map information storage unit 142 (step S122). The accuracy estimation unit 134 can execute the reference process of the map information of step S122, for example.

When referring to the map information that can determine the presence or absence of the influence of the magnetic disturbance in the above step S122, the portable terminal 100 subsequently determines whether or not the current position of the portable terminal 100 estimated in the above step S121 is the position that is influenced by the magnetic disturbance (step S123). The accuracy estimation unit 134 can execute the determination process of step S123, for example.

Upon determining whether or not the current position of the portable terminal 100 that is estimated in the above step S121 is the position that is influenced by the magnetic disturbance in the above step S123, the portable terminal 100 subsequently estimates the accuracy of the direction obtained by the sensing data output by the geomagnetism sensor 114, on the basis of the determination result in the above step S123 (step S124). The accuracy estimation unit 134 can execute the estimation process of the accuracy of the geomagnetism sensor 114 of step S124, for example.

That is, if the current position of the portable terminal 100 that is estimated in the above step S121 is the position that is influenced by the magnetic disturbance, the portable terminal 100 estimates that the accuracy of the sensing data output by the geomagnetism sensor 114 at that position is bad. On the other hand, if the current position of the portable terminal 100 that is estimated in the above step S121 is the position that is not influenced by the magnetic disturbance, the portable terminal 100 estimates that the accuracy of the direction obtained by the sensing data output by the geomagnetism sensor 114 at that position is good.

Upon estimating the accuracy of the direction obtained by the sensing data output by the geomagnetism sensor 114 in the above step S124, the portable terminal 100 subsequently estimates the direction of the portable terminal 100, by using the information relevant to the accuracy of the direction obtained by the sensing data output by the geomagnetism sensor 114, as illustrated in step S104 of FIG. 5.

The portable terminal 100 according to the second embodiment of the present disclosure can determine the presence or absence of the influence of the magnetic disturbance, even without performing the action recognition process by the action recognition unit 120, by using the map information stored in the map information storage unit 142, as described above. Then, the portable terminal 100 according to the second embodiment of the present disclosure estimates the accuracy of the direction obtained by the sensing data output by the geomagnetism sensor 114, by using the map information stored in the map information storage unit 142, as described above, in order to estimate the offset error of the gyro sensor 113, or correct the direction that is misaligned with time, by using the estimation result of the accuracy.

In the above, the exemplary operation of the portable terminal 100 according to the second embodiment of the present disclosure has been described. Note that, in the above second embodiment, a case that generates the map information 300 which indicates the region 310 where there is the influence of the magnetic disturbance has been described, but conversely the map generation unit 140 may generate map information that indicates a region in which there is no influence of temporal disturbance.

### [3.3. Exemplary Variant]

In the second embodiment of the above present disclosure, the configuration in which the map generation unit 140 and the map information storage unit 142 are included in the inner portion of the portable terminal 100 has been described, but the present disclosure is not limited to such an example. For example, a unit that has a function equivalent to the map generation unit 140 and the map information storage unit 142 may be included in the server device 200.

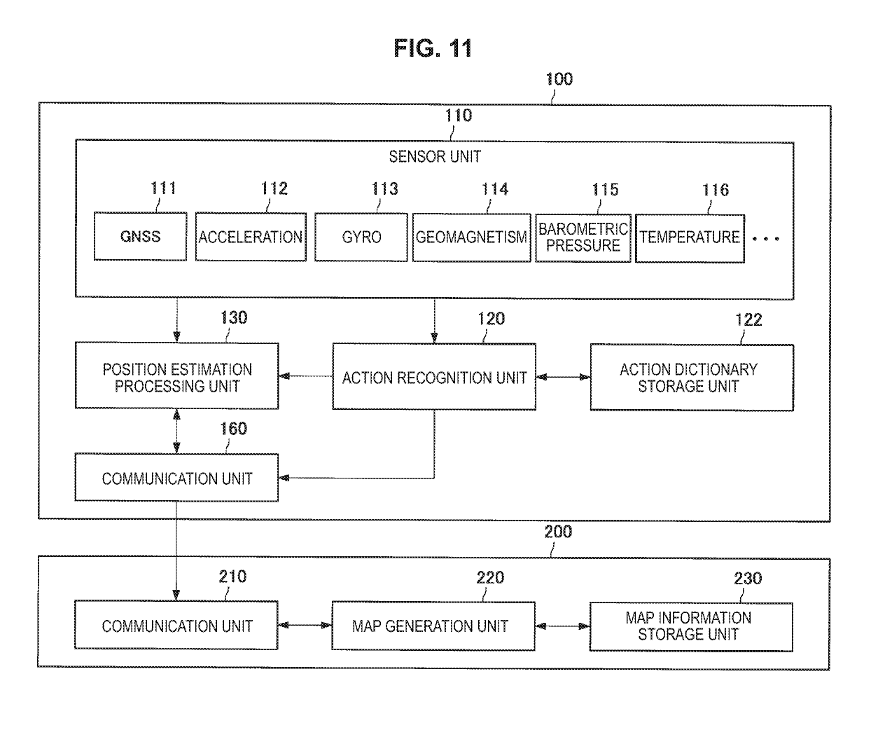

FIG. 11 is an explanatory diagram illustrating an exemplary variant of the second embodiment of the present disclosure. FIG. 11 illustrates an example in which a communication unit 210, a map generation unit 220, and a map information storage unit 230 are included in the server device 200. Also, FIG. 11 illustrates an example in which a communication unit 160 is included in the portable terminal 100.

When the portable terminal 100 is configured as in FIG. 11, the result of the action recognition process by the action recognition unit 120, and the result of the position estimation process by the position estimation processing unit 130 are transmitted from the communication unit 160 to the server device 200. Also, when the server device 200 is configured as in FIG. 11, the result of the action recognition process and the result of the position estimation process which are transmitted from the portable terminal 100 are used by the map generation unit 220, to form the map information stored in the map information storage unit 230.

Also, when the portable terminal 100 configured as in FIG. 11 refers to the map information stored in the server device 200, the position estimation processing unit 130 refers to the map information stored in the map information storage unit 230 via the communication unit 160. Then, the portable terminal 100 determines the presence or absence of the influence of the magnetic disturbance on the basis of the map information stored in the map information storage unit 230, and can estimate the accuracy of the direction obtained by the sensing data output by the geomagnetism sensor 114.

### 4. CONCLUSION

As described above, according to the first embodiment of the present disclosure, the portable terminal 100 that can estimate the offset error of the gyro sensor 113 or correct the direction that is misaligned with time on the basis of the sensing data output by the geomagnetism sensor 114 is provided. The portable terminal 100 according to the first embodiment of the present disclosure estimates the accuracy of the direction obtained by the sensing data output by the geomagnetism sensor 114, by using the recognition result of the action recognition unit 120, in order to estimate the offset error of the gyro sensor 113, or correct the direction that is misaligned with time, by using the estimation result of the accuracy.

Also, according to the second embodiment of the present disclosure, the portable terminal 100 that can determine the presence or absence of the influence of the magnetic disturbance, even without performing the action recognition process by the action recognition unit 120, by using the map information stored in the map information storage unit 142 is provided. Then, the portable terminal 100 according to the second embodiment of the present disclosure estimates the accuracy of the direction obtained by the sensing data output by the geomagnetism sensor 114 by using the map information stored in the map information storage unit 142, in order to estimate the offset error of the gyro sensor 113, or to correct the direction that is misaligned with time, by using the estimation result of the accuracy.

Also, a computer program for causing hardware such as a CPU, a ROM, and a RAM provided in each device to serve a function equivalent to the configuration of the above each device can be created. Also, a storage medium that stores the computer program can be provided. Also, a series of processes can be performed by hardware or a hardware circuit, by configuring the respective functional blocks illustrated in the functional block diagram with hardware or a hardware circuit.

Also, the portable terminal 100 according to each embodiment of the present disclosure may be performed as a device that is different from a device that includes a display that displays an image displayed as the result of processing of the portable terminal 100 (for example, a server device connected to the device that includes the display via a network such as the Internet), and may be performed by a terminal device that receives information from the server device. Also, the configuration of the portable terminal 100 according to an embodiment of the present disclosure may be implemented in a single and independent device, and may be implemented in a system in which a plurality of devices cooperate. For example, the system in which the plurality of devices cooperate can include a combination of a plurality of server devices, a combination of a server device and a terminal device, or the like.

Note that the software that configures the user interface and the application illustrated in the above embodiment may be configured as a web application that is used via a network such as the Internet. The web application may be configured by a markup language such as hypertext markup language (HTML), standard generalized markup language (SGML), and extensible markup language (XML), for example.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art based on the description of this specification.

Additionally, the present technology may also be configured as below.

(1) An information processing apparatus including:

an action recognition unit configured to recognize an action of a user that has a sensor by using first sensing data of the sensor; and

an accuracy estimation unit configured to estimate an accuracy of second sensing data of a geomagnetism sensor on the basis of a result of action recognition of the user obtained by the action recognition unit.

(2) The information processing apparatus according to (1), wherein

the accuracy estimation unit changes weight of usage of the second sensing data on the basis of the result of action recognition obtained by the action recognition unit, as the accuracy of the second sensing data.

(3) The information processing apparatus according to (1) or (2), wherein

the action recognition unit recognizes the action of the user by checking the first sensing data against dictionary information.

(4) The information processing apparatus according to (3), wherein

the dictionary information is information that contains information relevant to an action that gives influence on geomagnetism.

(5) The information processing apparatus according to (4), wherein

the accuracy estimation unit estimates the accuracy of the second sensing data on the basis of a probability that the action that gives influence on the geomagnetism is performed.

(6) The information processing apparatus according to (4) or (5), wherein

the dictionary information is information that contains information of the first sensing data when the user travels using a device that uses a motor.

(7) The row information processing apparatus according to (6), wherein

the device that uses the motor includes at least one of an elevator, an escalator, and an electrical train.

(8) The information processing apparatus according to any of (1) to (7), wherein

the first sensing data includes temperature data, and

the accuracy estimation unit performs a process for estimating the accuracy of the second sensing data, when an amount of change in the temperature data exceeds a predetermined amount.

(9) The information processing apparatus according to any of (1) to (8), wherein

the accuracy estimation unit performs a process for estimating the accuracy of the second sensing data, when a predetermined time elapses from a last process for estimating the accuracy of the second sensing data.

(10) The information processing apparatus according to any of (1) to (9), wherein

the action recognition unit recognizes the action of the user by analyzing the first sensing data.

(11) The information processing apparatus according to any of (1) to (10), further including:

a direction estimation unit configured to estimate a current direction on the basis of the accuracy of the second sensing data estimated by the accuracy estimation unit.

(12) The information processing apparatus according to (11), further including:

a speed estimation unit configured to estimate a current speed from the first sensing data; and

a position estimation unit configured to estimate a current position on the basis of the current direction estimated by the direction estimation unit and the current speed estimated by the speed estimation unit.

(13) An information processing method including:

recognizing an action of a user that has a sensor by using first sensing data of the sensor; and

estimating an accuracy of second sensing data of a geomagnetism sensor on the basis of a result of recognition of the action of the user.

(14) A computer program for causing a computer to execute:

recognizing an action of a user that has a sensor by using first sensing data of the sensor; and

estimating an accuracy of second sensing data of a geomagnetism sensor on the basis of a result of recognition of the action of the user.

### REFERENCE SIGNS LIST

1 user
10 portable terminal
100 portable terminal
110 sensor unit
111 GNSS sensor
112 acceleration sensor
113 gyro sensor
114 geomagnetism sensor
115 barometric pressure sensor
116 temperature sensor
120 action recognition unit
122 action dictionary storage unit
130 position estimation processing unit
200 server device

1. An information processing apparatus comprising:
an action recognition unit configured to recognize an action of a user that has a sensor by using first sensing data of the sensor; and
an accuracy estimation unit configured to estimate an accuracy of second sensing data of a geomagnetism sensor on the basis of a result of action recognition of the user obtained by the action recognition unit.

2. The information processing apparatus according to claim 1, wherein
the accuracy estimation unit changes weight of usage of the second sensing data on the basis of the result of action recognition obtained by the action recognition unit, as the accuracy of the second sensing data.

3. The information processing apparatus according to claim 1, wherein
the action recognition unit recognizes the action of the user by checking the first sensing data against dictionary information.

4. The information processing apparatus according to claim 3, wherein
the dictionary information is information that contains information relevant to an action that gives influence on geomagnetism.

5. The information processing apparatus according to claim 4, wherein
the accuracy estimation unit estimates the accuracy of the second sensing data on the basis of a probability that the action that gives influence on the geomagnetism is performed.

6. The information processing apparatus according to claim 4, wherein
the dictionary information is information that contains information of the first sensing data when the user travels using a device that uses a motor.

7. The information processing apparatus according to claim 6, wherein
the device that uses the motor includes at least one of an elevator, an escalator, and an electrical train.

8. The information processing apparatus according to claim 1, wherein
the first sensing data includes temperature data, and
the accuracy estimation unit performs a process for estimating the accuracy of the second sensing data, when an amount of change in the temperature data exceeds a predetermined amount.

9. The information processing apparatus according to claim 1, wherein
the accuracy estimation unit performs a process for estimating the accuracy of the second sensing data, when a predetermined time elapses from a last process for estimating the accuracy of the second sensing data.

10. The information processing apparatus according to claim 1, wherein
the action recognition unit recognizes the action of the user by analyzing the first sensing data.

11. The information processing apparatus according to claim 1, further comprising:
a direction estimation unit configured to estimate a current direction on the basis of the accuracy of the second sensing data estimated by the accuracy estimation unit.

12. The information processing apparatus according to claim 11, further comprising:
a speed estimation unit configured to estimate a current speed from the first sensing data; and
a position estimation unit configured to estimate a current position on the basis of the current direction estimated by the direction estimation unit and the current speed estimated by the speed estimation unit.

13. An information processing method comprising:
recognizing an action of a user that has a sensor by using first sensing data of the sensor; and
estimating an accuracy of second sensing data of a geomagnetism sensor on the basis of a result of recognition of the action of the user.

14. A computer program for causing a computer to execute:
recognizing an action of a user that has a sensor by using first sensing data of the sensor; and
estimating an accuracy of second sensing data of a geomagnetism sensor on the basis of a result of recognition of the action of the user.
